(19) United States
(12) Patent Application Publication
(10) Pub. No.: US 2003/0189824 A1
(43) Pub. Date: Oct. 9, 2003

(54) Portable reading light

(76) Inventors: Torre J. Meeder, West Bloomfield, MI (US); Scott G. Stephen, Chicago, IL (US)

Correspondence Address: FAY KAPLUN & MARCIN, LLP, 100 Maiden Lane, 17th F1, New York, NY, 10038, US

(21) Appl. No.: 10/116,642

(22) Filed: Apr. 3, 2002

(51) Int. Cl. F21V 21/084

(52) U.S. Cl. 362/105; 362/190; 362/800

(57) ABSTRACT

A reading light comprises a frame for supporting the reading light adjacent to a user's face and a first light source mounting member a first end of which is coupled to the frame, wherein a second end of the first light source mounting member is moveable with respect to the frame in combination with a first light emitting diode coupled to the second end of the first light source mounting member so that movement of the second end of the first light source mounting member relative to the frame redirects light emitted by the first light emitting diode.

### BACKGROUND INFORMATION

The present invention relates to a reading light assembly which allows a user to read or perform other functions in the absence of sufficient ambient light. Devices have been designed to be mounted on the head or on eyeglasses, but these inventions have proved overly cumbersome and/or heavy. Furthermore, the intensity of light generated is often low while an undesirable amount of heat is produced.

### SUMMARY OF THE INVENTION

The present invention is directed to a reading light comprising a frame for supporting the reading light adjacent to a user's face and a first light source mounting member a first end of which is coupled to the frame, wherein a second end of the first light source mounting member is moveable with respect to the frame in combination with a first light emitting diode coupled to the second end of the first light source mounting member so that movement of the second end of the first light source mounting member relative to the frame redirects light emitted by the first light emitting diode.

### BRIEF DESCRIPTION OF THE DRAWINGS

FIG. 1 shows an exemplary embodiment of a reader donning the present invention;

FIG. 2 is a top view of the preferred exemplary embodiment of the present invention;

FIG. 3 is a bottom view of the preferred exemplary embodiment of the present invention;

FIG. 4 shows an exemplary embodiment of a circuit system; and

FIG. 5 shows a side view of a lens system according to an embodiment of the invention.

### DETAILED DESCRIPTION

The present invention may be further understood with reference to the following description of preferred exemplary embodiments and the related appended drawings, wherein like elements are provided with the same reference numerals.

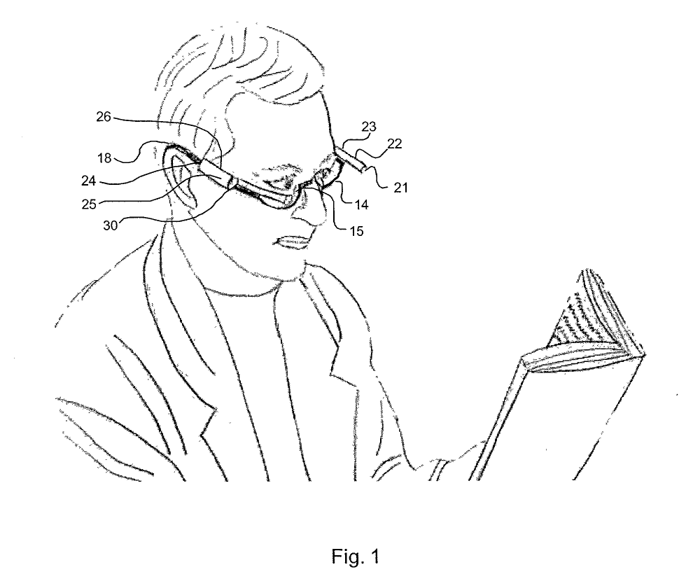

FIGS. 1-3 show an exemplary embodiment of an apparatus according to an exemplary embodiment of the present invention. The device 8 consists of a frame 12 that may, for example, mimic the frames of typical half-glasses, or the lower half of the frames of regular eyeglasses. The part of the frame 12 that is positioned in front of the user's face is comprised of a pair of semi-loops 14, coupled in a side-by-side substantially coplanar fashion. Of course, those skilled in the art will understand that the shape of the frame 12 may be changed in any way so long as, when the frame 12 is worn by the user, the light source is directed toward a desired position relative to the user's eyes. The semi-loops 14 are connected by nose pads 15 that rest on the bridge of the user's nose. The end of each of the semi-loops 14 forms a arm 16. Each of the arms 16 is attached to an outer end of a corresponding one of the semi-loops 14 by a hinge 30. Each of the hinges 30 also acts as a switch for an LED light 21 (discussed in detail below). Similar to the hinges on a standard pair of glasses, the hinges 30 allow the arms 16 to be folded in any position from a folded position substantially parallel to the semi-loops 14 to an open position substantially perpendicular to the semi-loops 14. The ends of the arms 16 opposite the hinges 30 may optionally consist of a pair of arcs 18 that rest on or grip the user's ears. As is known in the art, the combination of the nose pads 15 and the arms 16 hold the device 8 in position before the eyes of the user to direct the emitted light toward a focal point of the user's eyes. Those skilled in the art will recognize that the relative shape and size of the frames may be modified in order to maximize comfort for all users, to reduce manufacturing costs or to achieve a desired look, etc.

The present invention uses two white light emitting diodes (LEDs) 21 to supply light in the absence of ambient light or in situations where the ambient light is insufficient. The LEDs 21 may be, for example, standard ultra bright T-1¾ (5 mm) white LEDs available from Nichia America Corporation of Mountville, Pa. or a surface mount LED, e.g., Nichia America's part number #NSCW100. Each of the LEDs 21 is coupled to a power source (e.g., a AAA battery supplying 1.5 volts of direct current) via a circuit system which will be described below. As a large portion of the energy generated by the LEDs 21 radiates within the visible spectrum, the LEDs 21 provide increased light emitting efficiency while requiring a reduced power supply. Furthermore, this efficiency reduces the heat generated by the light source of the present invention and results in an increased time of operation with a lighter power source. In addition, the useful lifespan of LEDs 21 is also longer than that of standard light bulbs. The light from LEDs 21 is substantially focused in one direction. For example, when supplied with 20 milliAmps (mA), at a voltage of, for example, between 3.6 and 4.0 volts, a luminous intensity ranging from 320 milliCandles (mcd) to 380 mcd and a directivity of approximately 105 degrees to 110 degrees may be produced. The LEDs 21 described above are also small and light—approximately 3 millimeters (mm) in length, 2 mm in width and 1.2 mm in height. Each of these LEDs 21 may also include an electrical connection such as, for example, a soldering pad at a proximate end thereof.

Each of the LEDs 21 is attached to the frame 12 near one of the corresponding hinges 30 via a hollow, flexible LED holder 23 covered by an LED shroud 22. The LED shroud 22 protects the LED 21 from damage resulting from impact, abrasion, etc. Each flexible LED holder 23 houses the LED 21 at a distal end thereof facing away from the user. A proximal end of each flexible LED holder 23 is connected to the corresponding arm 16 and a first terminal of the LED 21 is coupled to the power source compartment 26. A second terminal of the LED 21 is coupled to ground 50. The flexible LED holders 23 may, for example, be made of a flexible rubber with a bendable wire mounted therein, as is well known in the art. Preferably, as will be understood by those of skill in the art, the material will retain a shape into which it is bent by a user so that the user may adjust the direction and focus of the light emitted from the LEDs 21. This allows users to effectively utilize the emitted light while minimizing the projection of light into areas where it is not wanted. In addition, the bendable wire mounted within the flexible rubber of the LED holders 23 may be used as a conductor to connect one of the first and second terminals of the LED 21 to either the power source compartment 26 or to ground while a wire extending through a central lumen of the LED holder 23 is coupled between the other of the first and second terminals and ground 50.

Coupled to each arm is an integrated voltage converter 25 and a power source compartment 26 receiving a power source 24 therein. The voltage converter 25 may be a standard DC-DC converter, for example, available from MAXIM Integrated Products of Sunnyvale, Calif. As will be understood by those skilled in the art, the specs for such standard DC-DC converters may be obtained from any manufacturer, including MAXIM Integrated Products. The converter is coupled to the power source 24 via a switch 30 to power the corresponding LED 21. The power source compartment 26 may comprise connectors, as are known in the art, to electrically couple the terminals of the power source 24 to the circuit to provide power therefrom to the rest of the circuit system and, consequently to the LED 21 when the corresponding switch 30 has been closed. For example, the power source compartment 26 may include a coiled spring contact within a substantially cylindrical compartment to maintain a cylindrical battery (e.g., AAA battery) in a desired position therein abutting a second contact. The arrangement of components and the circuit for each of the LEDs 21 may be substantially identical for each of the arms 16.

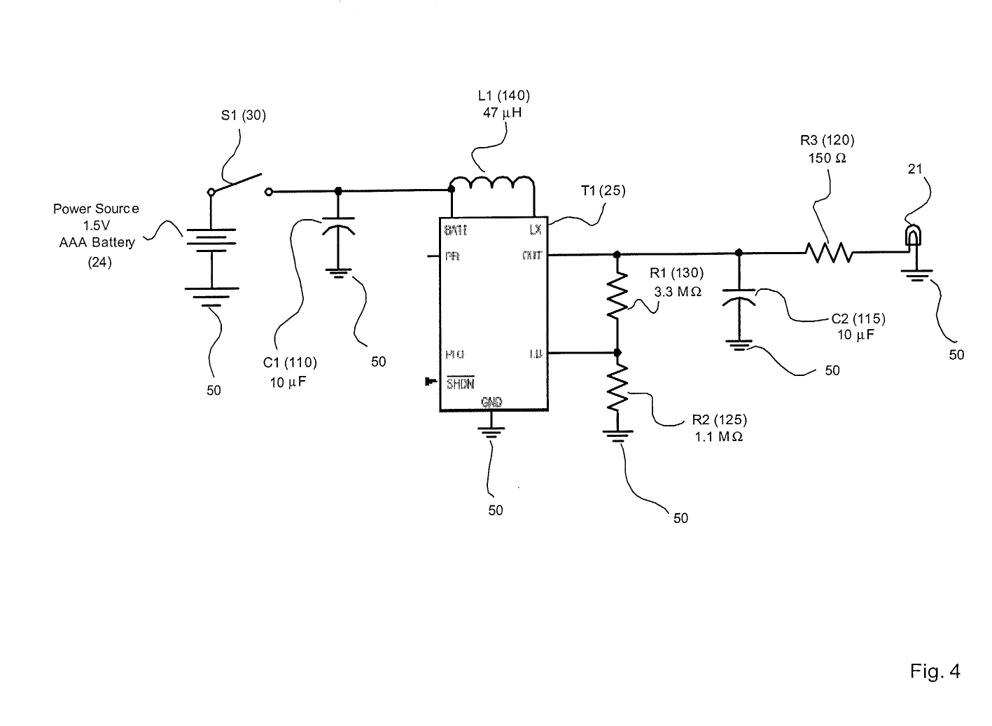

The power source 24 may be connected to the LED 21 via a circuit system as exemplified in FIG. 4. The power source is connected to the switch 30 which activates the LED 21 upon completing the circuit connection. In order to supply the proper current and voltage to the LED 21 from a 1.5 volt power source, the circuit may, for example, include two capacitors 110-115 in the circuit system, each of which may have a capacitance of 10 microFarads (μF) and three resistors 120, 125, and 130 having values of resistance, e.g., of 3.3 MegaOhms (MΩ), 1.1 MΩ, and 150 Ω, respectively. The circuit system may also consist of an inductor 140 with an exemplary inductance of 47 microhenry (μH). The power source 24, the capacitors 110-115, the voltage converter 25, the LED 21, and the resistor 125 may also be connected to ground 50 as shown in FIG. 4. The output voltage may be preset to 3.3V or may be adjusted from +2V to +5.5V. If, for example, there are three resistors as depicted in FIG. 4 with the above described values of resistance, the output voltage resulting from the circuit may be 5.0V.

The power source 24 may be connected to one terminal of the switch 30, while a second terminal thereof is coupled to the capacitor 110 and the inductor 140 as shown in FIG. 4. The inductor 140 is also connected to the converter 25. The resistor 130 is positioned between the “OUT” and “FB” pins of the converter 25 and the resistor 125 is attached to the resistor 130 at one end and to the ground 50 at the other. The resistor 130 is also connected to the second capacitor 115, which is also grounded. Finally the resistor connects the capacitor 115 to the LED 21 which is also grounded. Those skilled in the art will understand that the circuit diagram and the values presented in FIG. 4 only represent an exemplary model, and that there are other configurations which will be apparent to those of skill in the art in which the same functionality depicted in FIG. 4 may be obtained.

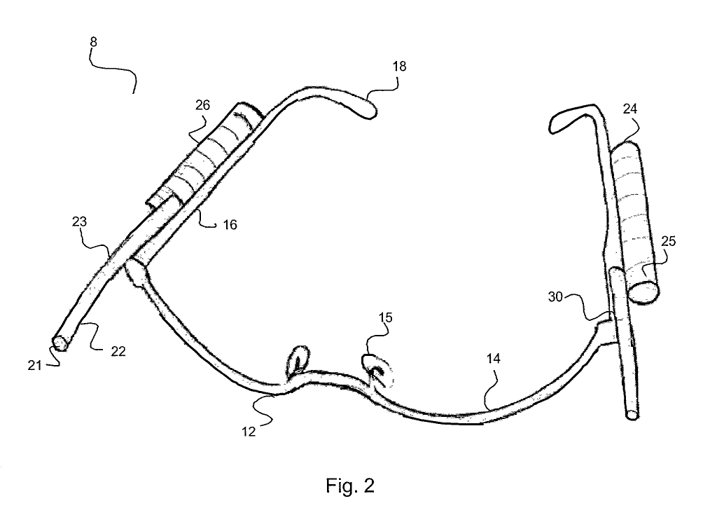

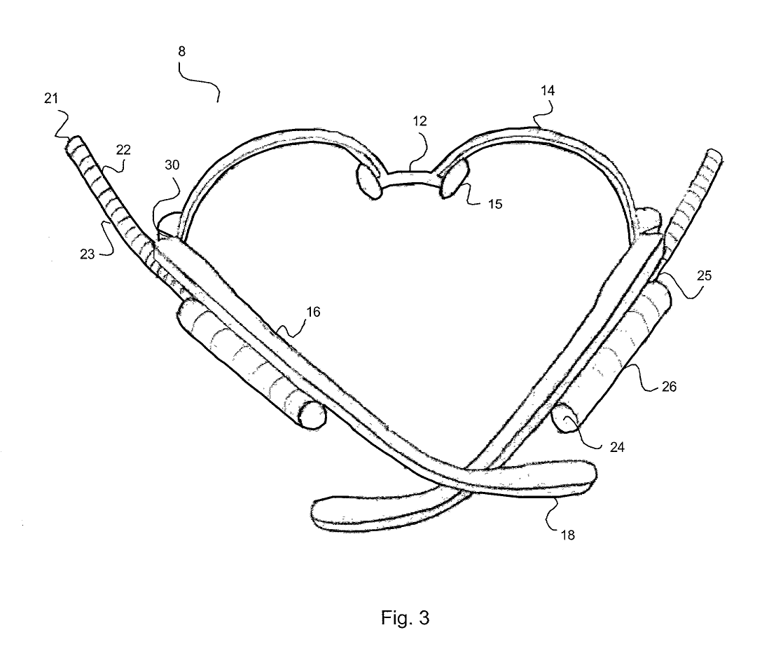

As described above, each of the arms 16 is connected to the front of the frame 12 by hinge 30. As shown in FIGS. 2 and 3, the user is free to move the arms 16 from a position substantially parallel to the frame 12, i.e. closed, to a position substantially perpendicular to the frame 12, i.e., open. When the arms 16 are placed in the open position, opposing surfaces of the arms 16 and the frame 12 forming contacts of the switches 30 come into contact closing the switches 30 and connecting the power source 24 to the LEDs 21 to illuminate the LEDs 21. Thus, movement of the arms 16 relative to the frame 12 acts as an automatic switch to ensure that when a user puts the device 8 on, the LEDs 21 automatically light and, when a user folds the arms 16 into the closed position, the LEDs 21 are extinguished. Those skilled in the art will understand that each of the LEDs 21 is activated independently of the other and, if the arm 16 on the right side is moved to the open position while the arm 16 on the left side remains in the closed position, only the LED 21 on the right side will be lit. When the user opens the glasses in order to place them on, the switches 30 on both sides are activated and both of the LEDs 21 are turned on. However, those skilled in the art will understand that a simple modification of the above described circuit may be employed which would prevent either of the LEDs 21 from being illuminated unless both switches 30 are closed (i.e., the arms 16 are both fully open). Furthermore, an apparatus may be produced, for example, which provides the required light with only one LED 21 or more than one LED 21 mounted on one side or the center of the frame.

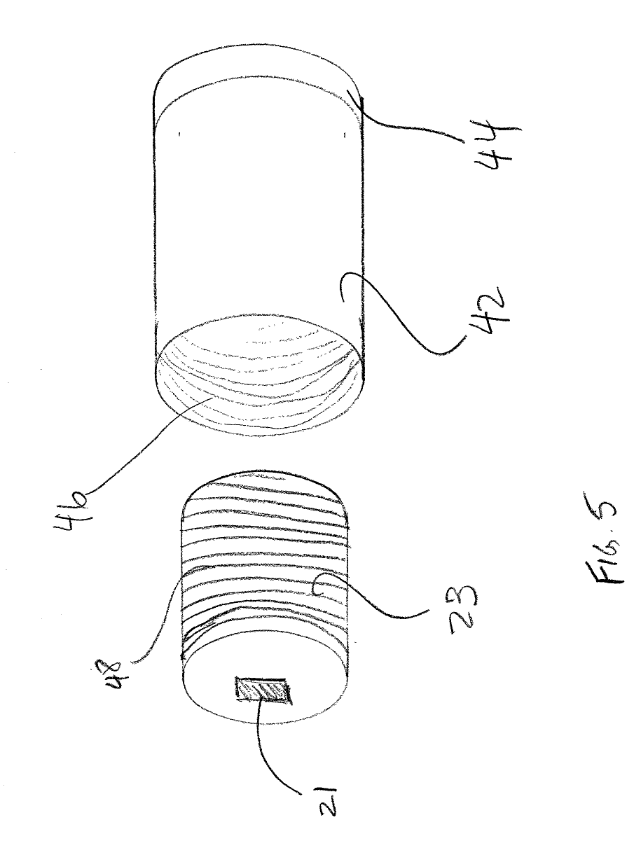

In addition, as shown in FIG. 5, the system according to the present invention may include a lens assembly 40 allowing the user to focus the light from the LEDs 21 at a desired distance therefrom. Specifically, as will be understood by those of skill in the art, a lens holding member 42 may be coupled to a lens 44 so that the lens holder 42 extends around the LED holder 23 to which the LED 21 is coupled. The lens holding member 42 is mounted to the LED holder 23 so that it may be moved proximally and distally therealong to bring the lens 44 closer to and further from the LED 21. As discussed above, in this example, the LED 21 is illustrated as a T-1¾ (5 mm) LED. To couple the lens holding member 42 to the LED holder 23, for example, the lens holding member 42 may include a threaded interior lumen which mates with a corresponding threaded exterior portion 48 of the LED holder 23 so that rotating the lens holding member relative to the LED holder 23 moves the lens 44 relative to the LED 21.

As to the manner of usage and operation of the present invention, the same should be apparent from the description presented above. Those skilled in the art will recognize that the optimum dimensional relationships for the parts of the invention, including the size, shape, form, materials, assembly and use are readily apparent and the relationships presented in the figures and detailed in the description above are intended to be encompassed by the present invention.

In the preceding specification, the present invention has been described with reference to specific exemplary embodiments thereof. It will, however, be evident that various modifications and changes may be made there unto without departing from the broadest spirit and scope of the invention as set forth in the appended claims. The specification and drawings are, therefore, to be regarded in an illustrative rather than restrictive sense.

What is claimed is:

1. A reading light comprising:
a frame for supporting the reading light adjacent to a user's face;
a first light source mounting member a first end of which is coupled to the frame, wherein a second end of the first light source mounting member is moveable with respect to the frame; and
a first light emitting diode coupled to the second end of the first light source mounting member so that movement of the second end of the first light source mounting member relative to the frame redirects light emitted by the first light emitting diode.

2. The reading light according to claim 1, wherein the frame includes a lateral member and two mounting arms rotatably coupled thereto, wherein, when in the operative position, the lateral member extends from a left to a right side of a user's head and each of the mounting arms extends from the lateral member to rest on a corresponding one of the user's ears, the reading light further comprising:
a first power source mounted to the frame; and
a first switch extending between a first one of the mounting arms and the lateral member so that, when the first mounting arm is in a first position substantially perpendicular to the lateral member, the first switch is closed and when the first mounting arm is not in the first position, the first switch is open, the first switch being electrically coupled to the first power source and the first light emitting diode so that, when the first mounting arm is in the first position, power flows from the first power source to the first light emitting diode.

3. The reading light according to claim 2, further comprising:
a second light source mounting member a first end of which is coupled to the frame, wherein a second end of the second light source mounting member is moveable with respect to the frame;
a second light emitting diode coupled to the second end of the second light source mounting member so that movement of the second end of the second light source mounting member relative to the frame redirects light emitted by the second light emitting diode;
a second power source mounted to the frame;
a second switch extending between a second one of the mounting arms and the lateral member so that, when the second mounting arm is in a first position substantially perpendicular to the lateral member, the second switch is closed and when the second mounting arm is not in the first position, the second switch is open, the second switch being electrically coupled to the second power source and the second light emitting diode so that, when the second mounting arm is in the first position, power flows from the second power source to the second light emitting diode.

4. The reading light according to claim 2, wherein the first power source is a DC power source and wherein a voltage regulating circuit is coupled between the first power source and the first light emitting diode, the voltage regulating circuit comprising a DC to DC converter.

5. The reading light according to claim 1, wherein at least a portion of the first light source mounting member is bendable to redirect light emitted from the first light emitting diode.

6. The reading light according to claim 2, wherein the first power source is mounted on the first mounting arm.

7. The reading light according to claim 1, wherein the first light emitting diode is a white light emitting diode.
